(19) United States
(12) Patent Application Publication
(10) Pub. No.: US 2026/0273976 A1
(43) Pub. Date: Sep. 17, 2026

(54) TEST PATTERN FORMING METHOD, ADJUSTMENT VALUE DETERMINATION METHOD, AND PRINTING APPARATUS

(71) Applicant: SEIKO EPSON CORPORATION, Tokyo (JP)

(72) Inventor: Tetsuya MATSUMURA, SUWA-SHI (JP)

(21) Appl. No.: 19/567,409

(22) Filed: Mar. 16, 2026

(30) Foreign Application Priority Data
Mar. 17, 2025 (JP) 2025-042144

(51) Int. Cl. B41J 29/393; B41J 2/145; B41J 19/18

(52) U.S. Cl. CPC B41J 29/393; B41J 2/145; B41J 19/18; B41J 2029/3935

(57) ABSTRACT

A test pattern includes a plurality of patches arranged in a predetermined direction. The plurality of patches include a plurality of first characteristic patches indicating a characteristic of printing first characteristics of a printing apparatus, and further include a plurality of second characteristic patches indicating a second characteristic of the printing characteristics. A test pattern forming method includes a first step of changing a relative positional relationship between a recording head and a medium, and a second step of ejecting a liquid from the recording head such that the test pattern is formed on the medium in which, in the predetermined direction, the first characteristic patches are not adjacent to each other and the second characteristic patches are not adjacent to each other among the plurality of patches.

The present application is based on, and claims priority from JP Application Serial Number 2025-042144, filed Mar. 17, 2025, the disclosure of which is hereby incorporated by reference herein in its entirety.

### BACKGROUND

### 1. Technical Field

The present disclosure relates to a test pattern forming method, an adjustment value determination method, and a printing apparatus.

### 2. Related Art

There is a case where a test pattern used to adjust the printing characteristics of a printing apparatus such as an inkjet printer is read by a scanner.

JP-A-2006-121486 discloses a printing correction method for generating printing correction data by using a digital camera to image a printing correction test pattern printed by a printer.

JP-A-2006-121486 is an example of the related art.

Assuming that a camera-equipped portable terminal such as a smartphone is used instead of a scanner in order to improve the convenience of printing characteristic adjustment, a photographer holds the camera-equipped portable terminal by hand and captures an image of a test pattern. In a case where the photographer has to capture an image of the test pattern by placing the portable terminal between a light source and the test pattern, shadows of the portable terminal itself, a member (for example, a tripod) holding the portable terminal, the body (for example, a hand) of the photographer, and the like are cast on the test pattern. A scanner can read the test pattern by irradiating the test pattern with light so that no shadow is cast thereon, but it may be difficult for the portable terminal to avoid the shadow from casting on the test pattern.

### SUMMARY

A test pattern forming method according to the present disclosure is a test pattern forming method for forming, on a medium, a test pattern for acquiring a printing characteristic of a printing apparatus including a recording head configured to eject a liquid onto the medium,
the test pattern including a plurality of patches arranged in a predetermined direction,
the plurality of patches including a plurality of first characteristic patches indicating a first characteristic of the printing characteristic and further including a plurality of second characteristic patches indicating a second characteristic of the printing characteristic,
the test pattern forming method including:
a first step of changing a relative positional relationship between the recording head and the medium; and
a second step of ejecting the liquid from the recording head such that the test pattern is formed on the medium in which, in the predetermined direction, the first characteristic patches are not adjacent to each other and the second characteristic patches are not adjacent to each other among the plurality of patches.

An adjustment value determination method according to the present disclosure is an adjustment value determination method including the test pattern forming method, the adjustment value determination method including:
a third step of determining an adjustment value for adjusting the printing characteristic based on an imaging result about the plurality of patches included in the test pattern.

Further, an adjustment value determination method according to the present disclosure is an adjustment value determination method including the test pattern forming method, the adjustment value determination method including:
a fourth step in which a control unit acquires an imaging result about the plurality of patches included in the test pattern from an imaging unit and determines, based on the imaging result, an adjustment value for adjusting the printing characteristic.

Further, a printing apparatus according to the present disclosure is configured including:
a recording head configured to eject a liquid onto a medium;
a drive unit configured to change a relative positional relationship between the recording head and the medium; and
a control unit configured to control formation of a test pattern for acquiring a printing characteristic of the printing apparatus, in which
the test pattern includes a plurality of patches arranged in a predetermined direction,
the plurality of patches include a plurality of first characteristic patches indicating a first characteristic of the printing characteristic, and further include a plurality of second characteristic patches indicating a second characteristic of the printing characteristic, and
the control unit controls the change in the relative positional relationship by the drive unit and the ejection of the liquid from the recording head such that the test pattern is formed on the medium in which, in the predetermined direction, the first characteristic patches are not adjacent to each other and the second characteristic patches are not adjacent to each other among the plurality of patches.

### BRIEF DESCRIPTION OF THE DRAWINGS

FIG. 1 schematically illustrates an example of a printing system.

FIG. 2 schematically illustrates a configuration example of the printing system.

FIG. 3 schematically illustrates an example of a recording head and a test pattern.

FIG. 4 schematically illustrates an example of a test pattern.

FIG. 5 schematically illustrates an example of a test pattern on which a shadow is cast.

FIG. 6 is a flowchart schematically illustrating an example of printing characteristic adjustment processing performed by a control unit.

FIG. 7 schematically illustrates an example of printing characteristic adjustment.

FIG. 8 schematically illustrates another example of the test pattern.

FIG. 9 schematically illustrates a state in which a shadow cast on a test pattern affects an adjustment value according to a comparative example.

FIG. 10 schematically illustrates a test pattern, on which a shadow is cast, according to the comparative example.

### DESCRIPTION OF EMBODIMENTS

Hereinafter, an embodiment of the present disclosure will be described. Obviously, the following embodiment merely illustrates the present disclosure, and all of the features described in the embodiment are not necessarily essential to the solutions disclosed herein.

### 1. OVERVIEW OF ASPECTS INCLUDED IN PRESENT DISCLOSURE

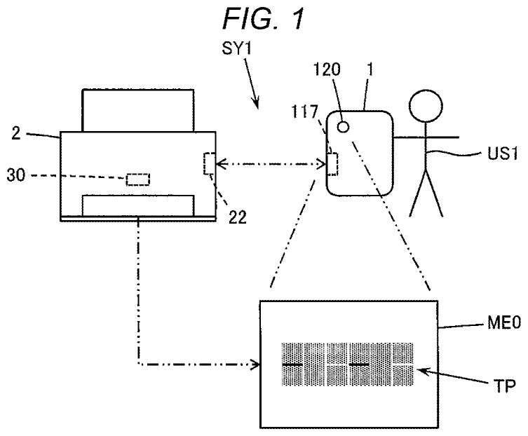

An overview of aspects included in the present disclosure will first be described with reference to examples illustrated in FIGS. 1 to 10. The drawings in the present application schematically illustrate examples, the magnification in each direction shown in the drawings may vary, and the drawings may not be consistent with each other. Obviously, respective elements in these aspects are not limited to specific examples denoted by the reference signs. In “Overview of aspects included in present disclosure”, a term in parentheses means a supplementary description of the term immediately before the parentheses.

In the present application, a numerical range “Min to Max” means numerals equal to or greater than a minimum value Min and equal to or less than a maximum value Max.

### Aspect 1

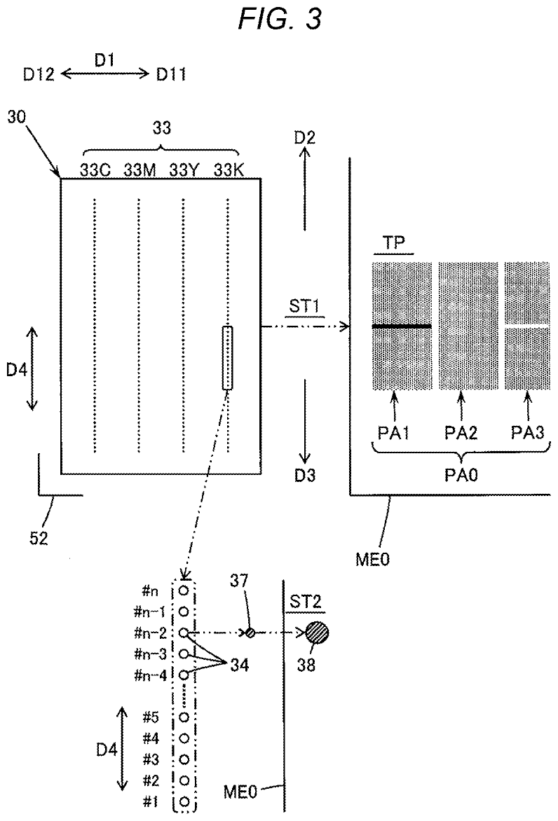

A test pattern forming method according to an aspect is a test pattern forming method of forming, on a medium ME0, a test pattern TP for acquiring printing characteristics of a printing apparatus 2 including a recording head 30 configured to eject a liquid 36 onto the medium ME0. The test pattern TP includes a plurality of patches PA0 arranged in a predetermined direction (for example, a main scanning direction D1). The plurality of patches PA0 include a plurality of first characteristic patches (for example, patches PA1) indicating a first characteristic of the printing characteristics, and further include a plurality of second characteristic patches (for example, patches PA2) indicating a second characteristic of the printing characteristics. As illustrated in FIGS. 3, 4 and 6, the test pattern method includes the following steps:
(a1) a first step ST1 of changing a relative positional relationship between the recording head 30 and the medium ME0; and
(a2) a second step ST2 of ejecting the liquid 36 from the recording head 30 such that the test pattern TP is formed on the medium ME0 in which, in the predetermined direction (D1), the first characteristic patches (PA1) are not adjacent to each other and the second characteristic patches (PA2) are not adjacent to each other among the plurality of patches PA0.

In the plurality of patches PA0 arranged in the predetermined direction (D1) in the formed test pattern TP, the first characteristic patches (PA1) are not adjacent to each other, and the second characteristic patches (PA2) are not adjacent to each other. Accordingly, even when a shadow SHO is cast on one of the first characteristic patches (PA1), the possibility that the shadow SHO is not cast on another first characteristic patch (PA1) increases, and even when the shadow SHO is cast on one of the second characteristic patches (PA2), the possibility that the shadow SHO is not cast on another second characteristic patch (PA2) increases. By acquiring the printing characteristics based on an imaging result about the plurality of patches PA0 including the plurality of first characteristic patches (PA1) and the plurality of second characteristic patches (PA2), the influence of the shadow SHO on the acquisition of the printing characteristics is reduced. Therefore, the above aspect can provide a test pattern forming method capable of reducing the influence of a shadow, which is generated at the time of imaging the test pattern, on the acquisition of the printing characteristics.

The above-described aspect includes various examples.

Examples of the printing characteristics include a conveyance amount of the medium, landing positions of droplets, and a density of a printed image. Density adjustment of the printed image may be density adjustment in units of nozzles.

Examples of the test pattern include a conveyance amount adjustment pattern for adjusting the conveyance amount of the medium on which the printed image is formed, a Bi-d adjustment pattern for performing Bi-d adjustment (bidirectional adjustment) for aligning the landing positions of the droplets between a forward path and a backward path, and a density pattern for adjusting the density of the printed image.

The predetermined direction may be a main scanning direction in which a recording head of a printing apparatus that performs main scanning and sub-scanning relatively moves during the main scanning, may be a sub-scanning direction intersecting the main scanning direction, or may be a conveyance direction of the medium.

The plurality of patches may be arranged in a row in the predetermined direction, or may be arranged in a matrix in the predetermined direction and a direction intersecting the predetermined direction.

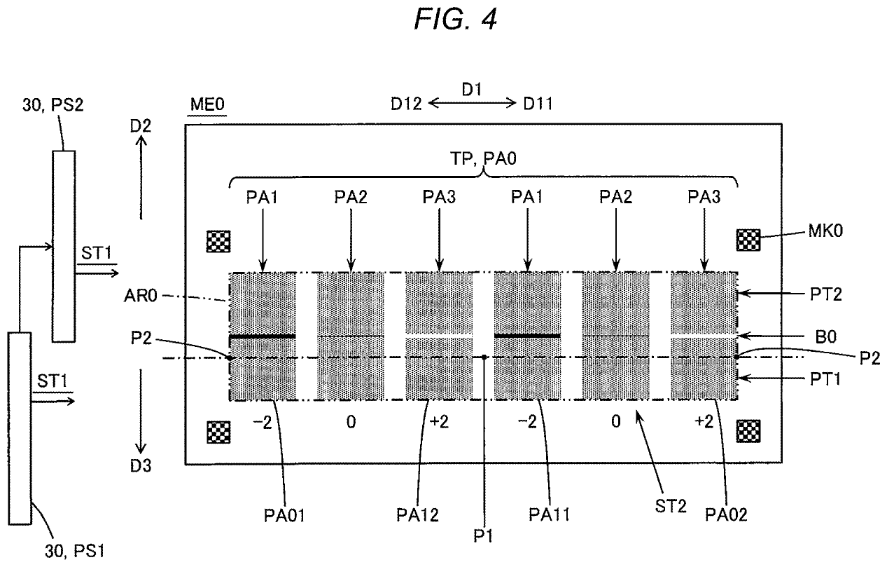

For example, the first characteristic patch may be applied to the patch PAL or the patch PA2 or the patch PA3 among the plurality of patches PA0 illustrated in FIG. 4. The second characteristic patch may be a patch different from the first characteristic patch, and may be applied to the patch PA2 or the patch PA3 or the patch PA1.

The plurality of patches arranged in the predetermined direction may include characteristic patches having the same characteristic adjacent to each other as long as the first characteristic patches are not adjacent to each other and the second characteristic patches are not adjacent to each other.

In the present application, “first”, “second”, and so on are terms used to identify each element in a plurality of elements similar to one another, and do not indicate the order.

Changing the relative positional relationship between the recording head and the medium may be moving the recording head without moving the medium, moving the medium without moving the recording head, or moving both the recording head and the medium.

Obviously, the additional remarks described above also apply to the following aspects.

### Aspect 2

As illustrated in FIG. 4 and the like, an area where the test pattern TP is formed on the medium ME0 is referred to as a test pattern formation area ARO. In the test pattern formation area ARO, the plurality of first characteristic patches (PA1) may include a first outer patch PA01 closer to an end position P2 in the predetermined direction (D1) than to an intermediate position P1 in the predetermined direction (D1) and a first inner patch PA11 closer to the intermediate position P1 than to the end position P2. In the second step ST2, the liquid 36 may be ejected from the recording head 30 such that the test pattern TP including the plurality of patches PA0 including a plurality of first characteristic patches (PA1) and a plurality of second characteristic patches (PA2) is formed on the medium ME0, the plurality of first characteristic patches (PA1) including the first outer patch PA01 and the first inner patch PA11.

In this case, even if an imaging result about the first outer patch PA01 included in the plurality of first characteristic patches (PA1) is affected by an aberration of an optical system such as a lens 121, an imaging result about the first inner patch PA11 included in the plurality of first characteristic patches (PA1) reduces the influence of the aberration on the acquisition of the printing characteristics. Therefore, the above aspect can provide a test pattern forming method capable of reducing the influence of an aberration, which is generated at the time of imaging the test pattern, on the acquisition of the printing characteristics.

In the test pattern formation area ARO, the plurality of second characteristic patches may include a second outer patch PA02 closer to the end position P2 than to the intermediate position P1 and a second inner patch PA12 closer to the intermediate position P1 than to the end position P2.

Since the patches PA0 of the same adjustment item are basically imaged at the same timing, the test pattern formation area ARO may be interpreted as an area in which at least all the patches PA0 of the same adjustment item are formed.

The additional remarks described above also apply to the following aspects.

### Aspect 3

As illustrated in FIG. 4 and the like, in the second step ST2, the liquid 36 may be ejected from the recording head 30 such that the test pattern TP including a plurality of patches PA0 is formed on the medium ME0 in which the first characteristic patch (PA1), the second characteristic patch (PA2), the first characteristic patch (PA1), and the second characteristic patch (PA2) are arranged in order in the predetermined direction (D1).

In this case, since a distance between the first characteristic patches (PA1) is not too short and a distance between the second characteristic patches (PA2) is not too short, it is possible to further reduce the influence of the shadow, which is generated at the time of imaging the test pattern, on the acquisition of the printing characteristics.

A third characteristic patch (for example, the patch PA3) may be added in the middle of the arrangement of the first characteristic patch (PA1), the second characteristic patch (PA2), the first characteristic patch (PA1), and the second characteristic patch (PA2), which is also included in Aspect 3.

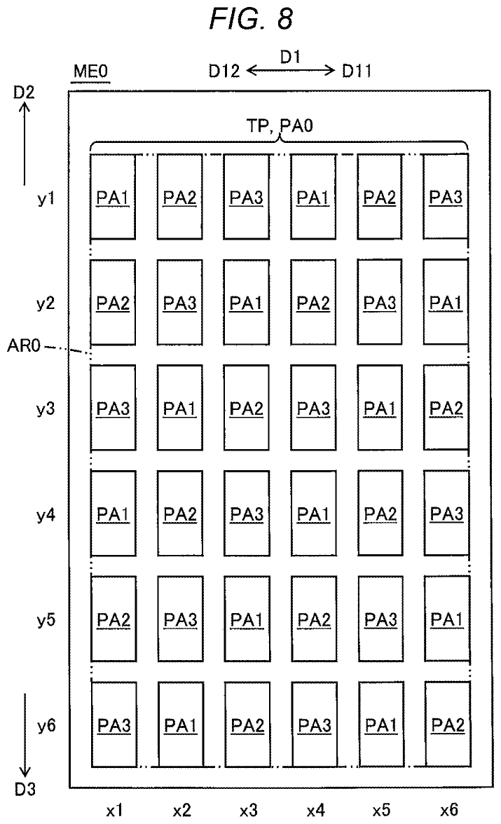

Aspect 4 As illustrated in FIG. 8, the plurality of patches PA0 may be arranged in the predetermined direction (D1) and an intersecting direction (for example, a sub-scanning direction D2) intersecting the predetermined direction (D1) in the test pattern TP. In the second step ST2, the liquid 36 may be ejected from the recording head 30 such that the test pattern TP is formed on the medium ME0 in which, in both the predetermined direction (D1) and the intersecting direction (D2), the first characteristic patches (PA1) are not adjacent to each other and the second characteristic patches (PA2) are not adjacent to each other among the plurality of patches PA0.

In this case, it is possible to reduce the influence of the shadow, which is generated at the time of imaging the test pattern including the plurality of patches arranged in the predetermined direction and the intersecting direction, on the the acquisition of printing characteristics.

### Aspect 5

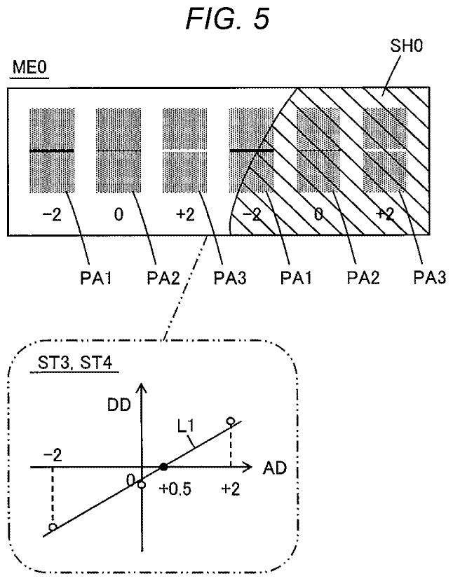

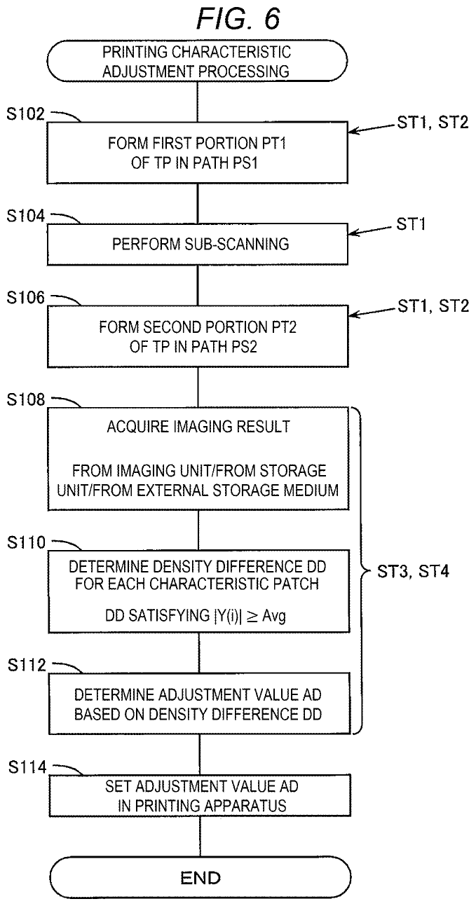

An adjustment value determination method according to an aspect is an adjustment value determination method including the test pattern forming method, and includes the following step as illustrated in FIGS. 5 and 6:
(a3) third step ST3 of determining, based on an imaging result about the plurality of patches PA0 included in the test pattern TP, an adjustment value AD for adjusting the printing characteristics.

In the third step ST3, a plurality of values (for example, individual density differences DD) respectively representing imaging results about the plurality of first characteristic patches (PA1) may be averaged, and the adjustment value AD may be determined based on the averaged value.

By determining the adjustment value AD for the printing characteristics based on the average value of the plurality of values respectively representing the imaging results about the plurality of first characteristic patches (PA1), the influence of a shadow on the adjustment value AD is reduced. Therefore, the above aspect can provide an adjustment value determination method capable of reducing the influence of a shadow, which is generated at the time of imaging the test pattern, on the adjustment value for the printing characteristics.

Obviously, in the third step ST3, a plurality of values respectively representing the imaging results about the plurality of second characteristic patches (PA2) may be averaged, and the adjustment value AD may be determined based on the averaged value.

### Aspect 6

The imaging result may include information with which a plurality of brightness values Y(i) each indicating brightness or a difference in brightness of the plurality of patches PA0 can be acquired. In the third step ST3, the plurality of brightness values Y(i) may be acquired from the respective imaging results about the plurality of first characteristic patches (PA1), and the adjustment value AD may be determined based on a value (for example, an individual density difference DD) representing the imaging result for a first characteristic patch (PA1), among the plurality of first characteristic patches (PA1), satisfying that an absolute value |Y(i)| of the brightness value is equal to or greater than an average value Avg {|Y(i)|} of absolute values of the plurality of brightness values.

The influence of a shadow on the adjustment value AD is reduced by determining the adjustment value AD based on the value representing the imaging result for a first characteristic patch (PA1), among the plurality of first characteristic patches (PA1), satisfying that the absolute value |Y(i)| of the brightness value is equal to or greater than the average value Avg {|Y(i)|} of the absolute values of the plurality of brightness values. Therefore, the above aspect can provide an adjustment value determination method capable of reducing the influence of a shadow generated at the time of imaging the test pattern on the adjustment value for the printing characteristics.

Obviously, in the third step ST3, the plurality of brightness values Y(i) may be acquired from the respective imaging results about the plurality of second characteristic patches (PA2), and the adjustment value AD may be determined based on a value representing the imaging result for a second characteristic patch (PA2), among the plurality of second characteristic patches (PA2), satisfying that the absolute value |Y(i)| of the brightness value is equal to or greater than the average value Avg {|Y(i)|} of the absolute values of the plurality of brightness values.

### Aspect 7

An adjustment value determination method according to another aspect is an adjustment value determination method including the test pattern forming method, and includes the following step as illustrated in FIGS. 5 and 6:
(a4) fourth step ST4 in which a control unit (for example, the control unit 110) acquires an imaging result about the plurality of patches PA0 included in the test pattern TP from an imaging unit 120, and determines, based on the imaging result, the adjustment value AD for adjusting the printing characteristics.

In this case, the imaging result about the plurality of patches PA0 is transferred from the imaging unit 120 to the control unit (110), and the control unit (110) determines the adjustment value AD based on the imaging result. Therefore, the above aspect can provide a highly convenient adjustment value determination method for reducing the influence of a shadow, which is generated at the time of imaging the test pattern, on the adjustment value for the printing characteristics.

Here, the control unit may be an information processing device separate from the printing apparatus and the imaging unit, or may be an information terminal integrated with the imaging unit. The additional remarks described above also apply to the following aspects.

### Aspect 8

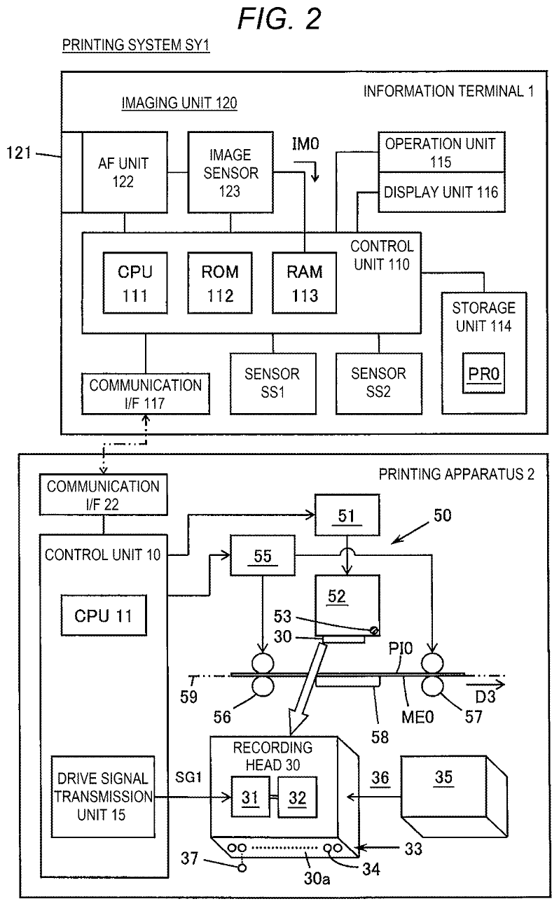

Further, as illustrated in FIG. 2, the printing apparatus 2 according to an aspect includes the recording head 30 configured to eject the liquid 36 onto the medium ME0, a drive unit 50 that changes a relative positional relationship between the recording head 30 and the medium ME0, and a control unit (for example, control unit 10, 110) that controls the formation of the test pattern TP for acquiring the printing characteristics of the printing apparatus 2. The control unit (10, 110) controls the change in the relative positional relationship by the drive unit 50 and the ejection of the liquid 36 from the recording head 30 such that the test pattern TP is formed on the medium ME0 in which, in the predetermined direction (D1), the first characteristic patches (PA1) are not adjacent to each other and the second characteristic patches (PA2) are not adjacent to each other among the plurality of patches PA0.

The above aspect provide a printing apparatus capable of reducing the influence of a shadow, which is generated at the time of imaging the test pattern, on acquisition of the printing characteristics.

Moreover, the above-described aspect can be applied to a printing system including the above-described printing apparatus and the above-described control unit, a control method for the above-described printing apparatus, a control program for the above-described printing apparatus, a computer-readable non-transitory medium in which the control program is recorded, and the like. The above-described printing apparatus may include a plurality of distributed portions, and the above-described control unit may include a plurality of distributed portions.

### (2) SPECIFIC EXAMPLE OF PRINTING SYSTEM THAT PERFORMS TEST PATTERN FORMING METHOD

FIG. 1 schematically illustrates a printing system SY1 including an information terminal 1 and the printing apparatus 2. FIG. 2 schematically illustrates a configuration of the printing system SY1. FIG. 3 schematically illustrates the recording head 30 and (a part of) the test pattern TP. FIG. 4 schematically illustrates the test pattern TP on the medium ME0. FIG. 4 illustrates relative positions of the recording head 30 in the sub-scanning direction D2 in a first path PS1 and a second path PS2 for convenience. In this specific example, it is assumed that the recording head 30 does not move in the sub-scanning direction D2 and the medium ME0 moves in a feeding direction D3 opposite to the sub-scanning direction D2.

Examples of the information terminal 1 include a mobile phone such as a smartphone, a tablet terminal, and a digital camera. The information terminal 1 may include a plurality of divided devices capable of communicating with each other, or may be a stationary apparatus to which an imaging unit is so coupled that the position thereof is changeable. The printing apparatus 2 is assumed to be an inkjet printer including the recording head 30 configured to eject droplets 37. The printing apparatus 2 may include a plurality of divided devices capable of communicating with each other.

The printing apparatus 2 can form, on the medium ME0, a printed image PIO including the test pattern TP for acquiring printing characteristics of the printing apparatus 2. A user US1 can adjust the printing characteristics of the printing apparatus 2 by using the information terminal 1 including the imaging unit 120 to capture an image of the test pattern TP. In a case where a scanner can be used to read the test pattern TP, the scanner can read the test pattern by applying light to the test pattern so that no shadow is cast thereon, and thus a shadow is unlikely to be included in a read image. However, when imaging the test pattern TP by an imaging device separate from the printing apparatus 2, the imaging is easily affected by an environment such as external light. Therefore, a shadow due to the information terminal 1 itself, a member (for example, a tripod) holding the information terminal 1, the body (for example, a hand) of the user US1, or the like may be included in a captured image IM0 including the test pattern TP. Further, the captured image IM0 may be affected by an aberration of the lens 121. Therefore, the plurality of patches PA0 included in the test pattern TP illustrated in FIG. 4 are configured on the premise that a shadow and a lens aberration occur. Even when the information terminal 1 is a non-portable stationary apparatus, the configuration of the plurality of patches PA0 illustrated in FIG. 4 is effective if the captured image IM0 is affected by a shadow or an aberration.

A communication interface (I/F) 117 of the information terminal 1 can communicate with a communication I/F 22 of the printing apparatus 2. The information terminal 1 can transmit a printing characteristic adjustment value and the like to the printing apparatus 2 via the communication I/Fs 117 and 22. Upon reception of the adjustment value, the printing apparatus 2 stores the adjustment value and adjusts the printing characteristics based on the adjustment value. The communication via the communication I/Fs 117 and 22 may be wireless communication compliant, for example, with a wireless local area network (LAN) standard, wired communication, or network communication such as the Internet.

The information terminal 1 illustrated in FIG. 2 includes the control unit 110, a storage unit 114, an operation unit 115, a display unit 116, the communication I/F 117, and the imaging unit 120. Since the information terminal 1 includes the imaging unit 120, the control unit 110 can also be referred to as an imaging control unit. The information terminal 1 may include sensors SS1 and SS2 coupled to the control unit 110. For example, the sensor SS1 may be a speed sensor that measures a moving speed of the imaging unit 120 or an acceleration sensor that measures acceleration of the imaging unit 120. The sensor SS2 may be a distance measuring sensor that measures a distance from the imaging unit 120 to the medium ME0. The control unit 110 includes a central processing unit (CPU) 111 that is a processor, a read only memory (ROM) 112, and a random access memory (RAM) 113.

The storage unit 114 stores a control program PRO and the like for capturing an image of the test pattern TP. As the storage unit 114, for example, a nonvolatile semiconductor memory such as a flash memory can be used. The storage unit 114 may be detachably attached to a main body of the information terminal 1. The display unit 116 displays, based display on information, a screen corresponding to the display information. As the display unit 116, for example, a liquid crystal display panel can be used. As the operation unit 115, a touch panel attached to the surface of the display unit 116, hardware keys, or the like can be used.

The imaging unit 120 includes the lens 121, an autofocus (AF) unit 122, an image sensor 123, and the like. The image sensor 123 converts an image of light incident via the lens 121 and the AF unit 122 into an electric signal. It is assumed that the image sensor 123 in the present specific example outputs digital data corresponding to electric signals from respective light receiving elements. The digital data is stored in the RAM 113 as frames or the captured image IM0. As the image sensor 123, a complementary metal-oxide semiconductor (CMOS) image sensor, a charge coupled device (CCD) image sensor, or the like can be used.

The printing apparatus 2 includes the control unit 10, the communication I/F 22, the recording head 30, the drive unit 50, a RAM (not illustrated), a storage unit (not illustrated), an operation panel (not illustrated), and the like. The control unit 10 of the printing apparatus 2 can also be referred to as a print control unit.

The control unit 10 includes a CPU 11, a color conversion unit (not illustrated), a halftone processing unit (not illustrated), a rasterization processing unit (not illustrated), and a drive signal transmission unit 15. Based on original image data acquired from the information terminal 1 or the like, the control unit 10 controls the main scanning and the sub-scanning by the drive unit 50 and the ejection of the droplets 37 by the recording head 30. The control unit 10 can be implemented by a system on a chip (SoC) or the like.

When the original image data is, for example, RGB data having integer values of 256 gradations for each of R (red), G (green), and B (blue) for each pixel, the above-described color conversion unit converts the RGB data into, for example, ink amount data having integer values of 256 gradations for each of C (cyan), M (magenta), Y (yellow), and K (black) for each pixel. The ink amount data represents usage amounts of inks of C, M, Y, and K, that is, the liquids 36 on a pixel basis. The halftone processing unit reduces the tone number of the tone values by performing halftone processing on tone values of pixels forming the ink amount data by any one of a dither method, an error diffusion method, and the like, and generates dot data. The dot data represents a formation state of dots 38 of the droplets 37 on a pixel basis. The rasterization processing unit described above generates raster data by performing rasterization processing of rearranging the dot data in the order in which the dots 38 are formed by the drive unit 50. The drive signal transmission unit 15 generates a drive signal SG1 from the raster data and outputs the drive signal SG1 to a drive circuit 31 of the recording head 30. The drive signal SG1 corresponds to a voltage signal applied to a drive element 32 of the recording head 30. When the dot data indicates “dot formation”, the drive signal transmission unit 15 outputs the drive signal SG1 for ejecting the droplets 37 for dot formation. The printed image PIO is formed on the medium ME0 according to the drive signal SG1.

The drive unit 50 includes a carriage drive unit 51 including a servo motor and a roller drive unit 55 including a servo motor. According to the control of the control unit 10, the drive unit 50 causes a carriage 52 to reciprocate along the main scanning direction D1 by driving of the carriage drive unit 51, and feeds the medium ME0 in the feeding direction D3 along a conveyance path 59 by driving of the roller drive unit 55. As illustrated in FIG. 3, the main scanning direction D1 is a direction intersecting an arrangement direction D4 of nozzles 34 in a nozzle row 33, and is, for example, a direction orthogonal to the arrangement direction D4. In FIG. 3, the right direction is a forward direction D11 of the main scanning, and the left direction is a backward direction D12 of the main scanning. The feeding direction D3 is a direction intersecting the main scanning direction D1, and is, for example, a direction orthogonal to the main scanning direction D1. It can be said that the carriage drive unit 51 performs the main scanning in which a relative positional relationship between the recording head 30 and the medium ME0 is changed along the main scanning direction D1. The roller drive unit 55 includes a conveyance roller pair 56 and a discharge roller pair 57. According to the control of the control unit 10, the roller drive unit 55 performs the sub-scanning of feeding the medium ME0 in the feeding direction D3 by rotating a driving conveyance roller of the conveyance roller pair 56 and a driving discharge roller of the discharge roller pair 57. It can be said that the roller drive unit 55 performs the sub-scanning in which the relative positional relationship between the medium ME0 and the recording head 30 is changed along the sub-scanning direction D2 intersecting the main scanning direction D1. Although the carriage 52 illustrated in FIG. 3 does not move in the sub-scanning direction D2, the drive unit 50 may implement the sub-scanning by moving the carriage 52 in the sub-scanning direction D2. At this time, the medium ME0 may not move in the sub-scanning direction D2, and the drive unit 50 may implement the sub-scanning by moving both the carriage 52 and the medium ME0 in the sub-scanning direction D2.

The medium ME0 is a print medium that holds a printed image. The material of the medium ME0 is not particularly limited, and various materials such as paper, resin, and metal are conceivable. The shape of the medium ME0 is not particularly limited, either, and various shapes such as a rectangular shape and a roll shape are conceivable, and the medium ME0 may have a three-dimensional shape.

A platen 58 is located below the conveyance path 59 and supports the medium ME0 by coming into contact with the medium ME0 located in the conveyance path 59. The recording head 30 is mounted at the carriage 52. A liquid cartridge 35 that supplies the liquid 36 to the recording head 30 to be ejected as the droplets 37 may be mounted at the carriage 52. Obviously, the liquid 36 may be supplied to the recording head 30 via a tube from the liquid cartridge 35 installed outside the carriage 52. The carriage 52 is fixed to an endless belt (not illustrated) and is movable in the main scanning direction D1 along a long guide 53 whose longitudinal direction is oriented in the main scanning direction D1. The recording head 30 includes the drive circuit 31, the drive element 32, and the like, and causes the liquid 36 to adhere to the medium ME0 by ejecting the droplets 37 toward the medium ME0 supported by the platen 58. It can be said that the control unit 10 controls the ejection of the droplets 37 from the recording head 30.

The drive circuit 31 applies a voltage signal to the drive element 32 according to the drive signal SG1 received from the drive signal transmission unit 15. The drive element 32 may be a piezoelectric element that applies pressure to the liquid 36 in a pressure chamber communicating with the nozzle 34, or may be a drive element or the like that generates air bubbles in the pressure chamber by heat and ejects the droplets 37 from the nozzle 34. The liquid 36 is supplied from the liquid cartridge 35 to the pressure chamber of the recording head 30. The liquid 36 in the pressure chamber is ejected as the droplets 37 from the nozzle 34 toward the medium ME0 by the drive element 32. Accordingly, the dots 38 of the droplets 37 are formed on the medium ME0, and the printed image PIO expressed by a pattern of the dots 38 is formed on the medium ME0.

The recording head 30 illustrated in FIG. 2 includes, at a nozzle surface 30a, the nozzle row 33 in which a plurality of the nozzles 34 that can eject the droplets 37 onto the medium ME0 are arranged at an interval, which is a predetermined nozzle pitch, in the arrangement direction D4. Here, the nozzle refers to a small hole through which droplets are ejected, and the nozzle row refers to an array of a plurality of nozzles. The nozzle surface 30a is an ejection surface of the droplets 37. The nozzle row 33 includes, for example, a C nozzle row 33C that can eject the C liquid 36 onto the medium ME0, an M nozzle row 33M that can eject the M liquid 36 onto the medium ME0, a Y nozzle row 33Y that can eject the Y liquid 36 onto the medium ME0, and a K nozzle row 33K that can eject the K liquid 36 onto the medium ME0. In each of the nozzle rows (33C, 33M, 33Y, 33K) illustrated in FIG. 3, the plurality of nozzles 34 are arranged in one row at an interval of the predetermined nozzle pitch in the arrangement direction D4. The plurality of nozzles 34 in each nozzle row (33C, 33M, 33Y, 33K) may be arranged in a staggered manner, that is, in two rows at an interval of the predetermined nozzle pitch in the arrangement direction D4. Here, the arrangement direction of the plurality of nozzles 34 arranged in a staggered manner is an arrangement direction of the nozzles focusing on each of the two rows.

As illustrated in FIG. 4, the test pattern TP may be printed on the medium ME0, and one or more position detection patterns MKO for specifying positions of the patches PA0 may be printed outside the test pattern TP. Examples of the position detection pattern MKO include a square ArUco marker having a specific geometric feature, a triangular pattern, and the like.

The test pattern TP illustrated in FIG. 4 includes a plurality of patches PA0 for performing PF adjustment (paper feed adjustment) of adjusting a feed amount in the sub-scanning direction that is, a conveyance amount of the medium ME0 during the sub-scanning without excess or deficiency. It can be said that the test pattern TP includes a plurality of patches PA0 for setting the adjustment value AD (see FIG. 5) for the PF adjustment.

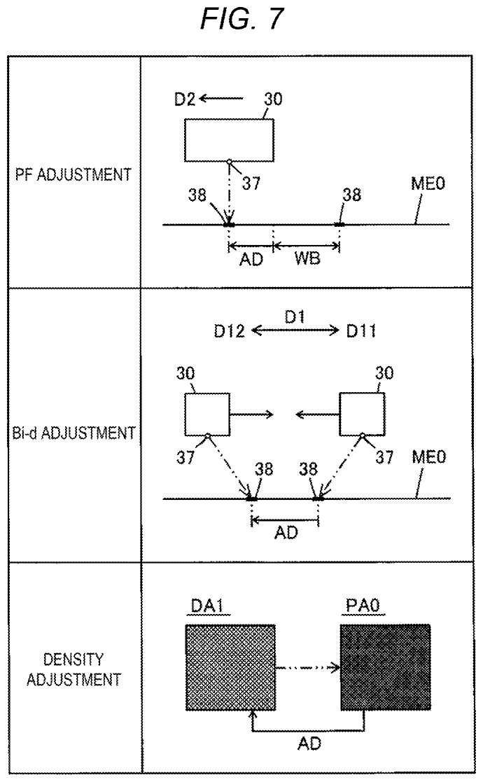

Here, the PF adjustment will be described as an example of printing characteristic adjustment with reference to the upper part of FIG. 7.

When the feed amount is too large, a streak, for example, a light streak is generated in which a gap is generated between band regions. When the feed amount is too small, a streak, for example, a dark streak is generated in which the dots 38 overlap in the band regions. For example, it is assumed that an interval between landing positions of the droplets 37 between the sub-scanning in the sub-scanning direction D2 is larger than a width WB of a design band region, as illustrated in the upper part of FIG. 7. In this case, an interval between the dot 38 formed on the medium ME0 by the droplet 37 ejected from a certain nozzle 34 in a certain pass and the dot 38 formed on the medium ME0 by the droplet 37 ejected from the same nozzle 34 in the previous pass is wider than the width WB of the band region. For example, the control unit 110 of the information terminal 1 can cause the printing apparatus 2 to execute the PF adjustment by setting the adjustment value AD, which corresponds to a deviation of the interval between the dots 38 with respect to the width WB of the band region, in the control unit 10 of the printing apparatus 2. The control unit 10 of the printing apparatus 2 can adjust the feed amount so as not to be excessive or deficient in the sub-scanning direction D2 by reducing the feed amount according to the adjustment value AD. Obviously, when the interval between the landing positions of the droplets 37 between the sub-scanning in the sub-scanning direction D2 is smaller than the width WB of the design band region, the feed amount can be adjusted without excess or deficiency by setting the adjustment value AD.

The plurality of patches PA0 illustrated in FIG. 4 include two patches PA1 indicating a characteristic when the adjustment value AD is set to −2 for the feed amount, two patches PA2 indicating a characteristic when the adjustment value AD is set to 0 for the feed amount, and two patches PA3 indicating a characteristic when the adjustment value AD is set to +2 for the feed amount. The adjustment value AD may or may not be printed in the vicinity of the corresponding patch PA0 on the medium ME0. In the example illustrated in FIG. 4, the feed amount is an example of the printing characteristic, the patch PA1 is an example of a first characteristic patch indicating a first characteristic regarding the feed amount, the patch PA2 is an example of a second characteristic patch indicating a second characteristic regarding the feed amount, and the patch PA3 is an example of a third characteristic patch indicating a third characteristic regarding the feed amount. It can be said that the test pattern TP includes a plurality of characteristic patches (PA1 to PA3) arranged in the main scanning direction D1 as an example of the predetermined direction. Each patch PA0 includes a first portion PT1 formed on the medium ME0 in the path PS1 meaning one time of main scanning and a second portion PT2 formed on the medium ME0 in the path PS2 meaning another time of main scanning after the one time of main scanning. Based on test pattern print data for printing the test pattern TP, the control unit 10 of the printing apparatus 2 controls the change in the relative positional relationship between the recording head 30 and the medium ME0 by the drive unit 50 and the ejection of the droplets 37 from the recording head 30 such that the entire first portion PT1 is printed during the movement of the recording head 30 in the main scanning direction D1 in the path PS1 and the entire second portion PT2 is printed during the movement of the recording head 30 in the main scanning direction D1 in the path PS2 after one time of sub-scanning. A movement direction of the recording head 30 in the path PS1 may be either the forward direction D11 or the backward direction D12, and the movement direction of the recording head 30 in the path PS2 may be either the forward direction D11 or the backward direction D12.

In FIG. 4, the patch PA1 means a first characteristic patch in which the second portion PT2 is formed in the path PS2 such that paper feeding by a feed amount corresponding to an adjustment value −2, that is, conveyance of the medium ME0 is performed after the formation of the first portion PT1 in the path PS1. When the feed amount is smaller than an optimum feed amount, the first portion PT1 and the second portion PT2 partially overlap each other in the sub-scanning direction D2, and as a result, a dark streak along the main scanning direction D1 is generated at a boundary portion BO between the first portion PT1 and the second portion PT2. When the K liquid 36 is used in forming the patch PA0, a black streak is generated at the boundary portion BO. The patch PA2 means a second characteristic patch in which the second portion PT2 is formed in the path PS2 such that paper feeding by a feed amount corresponding to an adjustment value 0 is performed after the formation of the first portion PT1 in the path PS1. The patch PA3 means a third characteristic patch in which the second portion PT2 is formed in the path PS2 such that paper feeding by a feed amount corresponding to an adjustment value +2 is performed after the formation of the first portion PT1 in the path PS1. When the feed amount is larger than the optimum feed amount, the first portion PT1 and the second portion PT2 are separated from each other in the sub-scanning direction D2, and as a result, a light streak in a ground color along the main scanning direction D1 is generated at the boundary portion BO between the first portion PT1 and the second portion PT2. When the medium ME0 is white, a white streak is generated at the boundary portion BO. When the feed amount is optimum, neither a dark streak nor a light streak is generated at the boundary portion BO.

For example, the control unit 10 changes a use range of the nozzle 34 according to the characteristic patches (PA1 to PA3) in the path PS2. Here, as illustrated in FIG. 3, in the nozzle row 33, n nozzles 34 used for forming the patch PA0 are referred to as #1 to #n sequentially in the sub-scanning direction D2. The nozzle #1 is located most downstream in the feeding direction D3, and the nozzle #n is located most upstream in the feeding direction D3. When forming the patch PA1 with the adjustment amount-2, the control unit 10 causes the droplets 37 to be ejected from, for example, the nozzles #1 to #n such that the second portion PT2 is formed by a feed amount corresponding to the adjustment value −2 in the path PS2. When forming the patch PA2 with the adjustment amount of 0, the control unit 10 causes the droplets 37 to be ejected from, for example, the nozzles #3 to #n without using the nozzles #1 and #2 such that the second portion PT2 is formed by a feed amount corresponding to the adjustment value of 0 in the path PS2. When forming the patch PA3 with the adjustment amount-2, the control unit 10 causes the droplets 37 to be ejected from, for example, the nozzles #5 to #n without using the nozzles #1 to #4 such that the second portion PT2 is formed by a feed amount corresponding to the adjustment value −2 in the path PS2.

As described above, the first portion PT1 of all the patches PA0 can be formed on the medium ME0 in the path PS1, and the second portion PT2 of all the patches PA0 can be formed on the medium ME0 in the path PS2.

At the boundary portion BO of each patch PA0, shading corresponding to the adjustment amount AD occurs. For example, when a density difference DD (see FIG. 5) is represented by a difference value obtained by subtracting lightness L* of a portion excluding the boundary portion BO from lightness L′ of the boundary portion BO in the patch PA0, the adjustment value to be set in the printing apparatus 2 can be determined based on a correspondence relationship between the adjustment value AD and the density difference DD for the characteristic patches (PA1 to PA3). The lightness L′ means lightness L′ of the CIE (International Commission on L* a* b* color space, and represents brightness. Hereinafter, “*” is omitted. When the captured image IM0 of the test pattern TP is RGB data, the shading of the patch PA0 as an imaging result can be represented by an average value of an R value, a G value, and a B value, for example, an additive average value. When this average value is referred to as an RGB average value, the RGB average value also represents brightness. It can be said that the imaging result includes information with which a plurality of brightness values each indicating the brightness or a difference in brightness of the plurality of patches PA0 can be acquired. Therefore, the density difference DD can be represented by a difference value obtained by subtracting an RGB average value of the portion excluding the boundary portion BO from an RGB average value of the boundary portion BO in the patch PA0 as the imaging result.

In other words, the density difference DD can be said to be a value obtained by subtracting a density of the boundary portion BO from a density of the portion excluding the boundary portion BO in the patch PA0.

As illustrated in FIG. 4, a rectangular area in which the test pattern TP is formed in the medium ME0 is set as the test pattern formation area ARO. The test pattern formation area ARO is an area including a gap between the patches PA0 if the gap is present, and is an area surrounded by edges of patches at ends in the main scanning direction D1 and edges of the patches PA0 in the sub-scanning direction D2. In the test pattern formation area ARO, the two patches PA1 include the first outer patch PA01 closer to the end position P2 in the main scanning direction D1 than to the intermediate position P1 in the main scanning direction D1 and the first inner patch PA11 closer to the intermediate position P1 than to the end position P2. When the patch PA3 is applied to the second characteristic patch, it can be said that the two patches PA3 include the second outer patch PA02 closer to the end position P2 in the main scanning direction D1 than to the intermediate position P1 in the main scanning direction D1 and the second inner patch PA12 closer to the intermediate position P1 than to the end position P2 in the test pattern formation area ARO.

The plurality of patches PA0 illustrated in FIG. 4 include the patch PA1, the patch PA2, the patch PA3, the patch PA1, the patch PA2, and the patch PA3 in order in the main scanning direction D1. Since the distance between the patches PA1 is equal to the distance between the patches PA2 and is equal to the distance between the patches PA3, a possibility that each patch PA0 is affected by the shadow SHO can be equalized.

As described above, it can be said that, in the plurality of patches PA0, the patches PA1 are not adjacent to each other, the patches PA2 are not adjacent to each other, and the patches PA3 are not adjacent to each other.

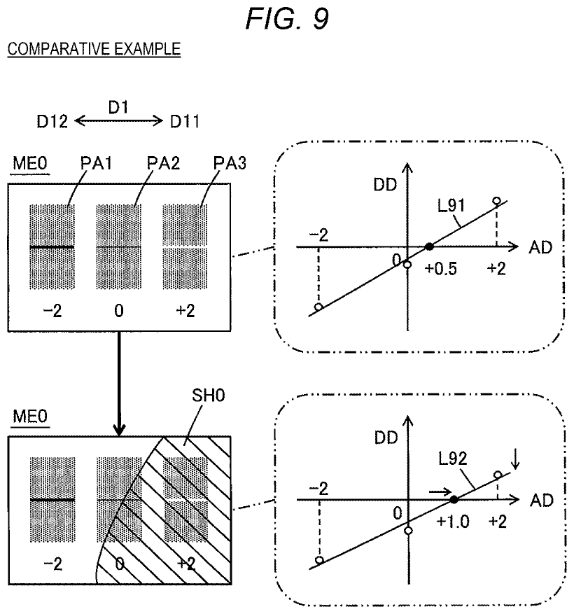

FIG. 9 schematically illustrates a state in which the shadow SHO cast on a test pattern according to a comparative example including the patches PA1 to PA3 different from the arrangement of a plurality of patches PA0 illustrated in FIG. 4 affects the adjustment value AD. An upper part of FIG. 9 illustrates the medium ME0 on which the shadow SHO is not cast, and a correspondence relationship between the adjustment value AD and the density difference DD in this case (in an area surrounded by a two-dot chain line). A lower part of FIG. 9 illustrates the medium ME0 on which the shadow SHO is cast, and a correspondence relationship between the adjustment value AD and the density difference DD in this case (in an area surrounded by a two-dot chain line).

The test pattern on the medium ME0 includes one patch PA1 with the adjustment value −2, one patch PA2 with the adjustment value 0, and one patch PA3 with the adjustment value +2.

When the shadow SHO is not cast on the medium ME0, an approximate straight line L91 representing the correspondence relationship between the adjustment value AD and the density difference DD can be obtained based on the density differences DD (−2), DD (0), and DD (+2) respectively obtained from the imaging results about the patches PA1, PA2, and PA3. The adjustment value AD at a point where the approximate straight line L91 and an AD axis intersect is the adjustment value to be set in the printing apparatus 2. In the example illustrated in the upper part of FIG. 9, the approximate straight line L91 intersects the AD axis at a position of AD=+0.5, and AD=+0.5 is set in the printing apparatus 2.

When the shadow SHO is cast on the medium ME0, the density difference DD obtained from the imaging result may be affected. In the example illustrated in the lower part of FIG. 9, since the shadow SHO overlaps the entire patch PA3, the density difference DD (+2) obtained from the imaging result is smaller than that in the case where the shadow SHO is not present. Further, since the shadow SHO overlaps a part of the patch PA2, the density difference DD (0) obtained from the imaging result is smaller than that in the case where the shadow SHO is not present. As a result, an approximate straight line L92 obtained based on the density differences DD (−2), DD (0), and DD (+2) deviates from the approximate straight line L91, and an error occurs in the adjustment value to be set. In the example illustrated in the lower part of FIG. 9, the approximate straight line L92 intersects the AD axis at a position of AD=+1.0, and AD=+1.0 is set in the printing apparatus 2.

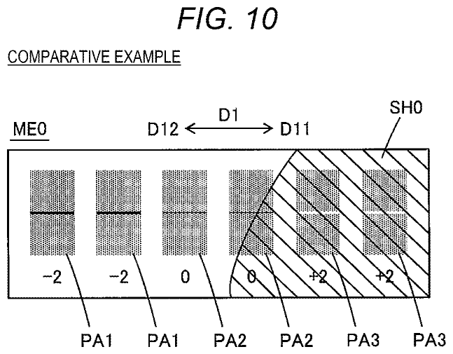

Here, as in a comparative example illustrated in FIG. 10, it is assumed that a test pattern is formed on the medium ME0 in which the patches PA1, the patches PA2, and the patches PA3 are arranged so as to be adjacent to each other in the main scanning direction D1. In the example illustrated in FIG. 10, when the shadow SHO overlaps two adjacent patches PA3, the density difference DD (+2) obtained from the imaging result is affected, and an error occurs in the adjustment value to be set.

FIG. 5 schematically illustrates an example in which the shadow SHO is cast on the test pattern TP illustrated in FIG. 4.

In the test pattern TP of this specific example, a plurality of patches PA0 are arranged such that patches having the same characteristic are not adjacent to each other in the main scanning direction D1. Therefore, even when an imaging result in which the shadow SHO overlaps a part of the plurality of patches PA0 is obtained, there is a high possibility that the shadow SHO does not overlap a part of patches among a plurality of patches having the same characteristic. Accordingly, the density difference DD that is less affected by the shadow SHO can be obtained for each characteristic, an approximate straight line L1 close to the approximate straight line L91 shown in the upper part of FIG. 9 can be obtained, and an adjustment value that is less affected by the shadow SHO can be set in the printing apparatus 2.

### (3) SPECIFIC EXAMPLE OF PRINTING CHARACTERISTIC ADJUSTMENT PROCESSING

FIG. 6 schematically illustrates the printing characteristic adjustment processing mainly performed by the control unit 110) of the information terminal 1 illustrated in FIGS. 1 and 2. In FIG. 6, the test pattern is denoted by TP. In FIG. 6, steps S102 to S106 correspond to the first step ST1 of changing the relative positional relationship between the recording head 30 and the medium ME0. FIGS. 3 and 4 also illustrate the first step ST1. Steps S102 and S106 correspond to the second step ST2 of ejecting the liquid 36 from the recording head 30 such that the test pattern TP as illustrated in FIG. 4 is formed on the medium ME0. FIGS. 3 and 4 also illustrate the second step ST2. Steps S108 to S112 correspond to the third step ST3 of determining the adjustment value AD based on the imaging result about the plurality of patches PA0 included in the test pattern TP, and the fourth step ST4 in which the control unit 110 acquires the imaging result from the imaging unit 120 and determines the adjustment value AD based on the imaging result. FIG. 5 also illustrates the third step ST3 and the fourth step ST4. Hereinafter, the description of “step” may be omitted, and signs of the steps may be shown in parentheses. The printing characteristic adjustment processing starts when the control unit 110 receives an adjustment instruction about the feed amount via the operation unit 115.

When the printing characteristic adjustment processing is started, the control unit 110 causes the printing apparatus 2 to print the test pattern TP as illustrated in FIG. 4 (S102 to S106). At this time, the control unit 110 may transmit the test pattern print data for implementing the processing of S102 to S106 to the printing apparatus 2. According to the test pattern print data, the control unit 10 of the printing apparatus 2 controls the change in the relative positional relationship between the recording head 30 and the medium ME0 by the drive unit 50 and the ejection of the droplets 37 from the recording head 30. First, in the path PS1, the control unit 10 causes the recording head 30 to eject, for example, the droplets 37 of K so that the first portion PT1 of all the patches PA0 is formed on the medium ME0 according to the test pattern print data while moving the recording head 30 in the main scanning direction D1 (S102). After the first portion PT1 is formed, the control unit 10 performs sub-scanning processing of conveying the medium ME0 in the feeding direction D3 by the current feed amount (S104). After the sub-scanning, the control unit 10 causes the recording head 30 to eject, for example, the droplets 37 of K so that the second portion PT2 of all the patches PA0 is formed on the medium ME0 according to the test pattern print data while moving the recording head 30 in the main scanning direction D1 in the path PS2 (S106).

As described above, the control units 10 and 110 control the change in the relative positional relationship between the recording head 30 and the medium ME0 by the drive unit 50 and the ejection of the liquid 36 from the recording head 30 such that the test pattern TP including a plurality of patches PA0 is formed on the medium ME0 in which the patch PA1, the patch PA2, the patch PA3, the patch PA1, the patch PA2, and the patch PA3 are arranged in order in the main scanning direction D1. It can be said that the control units 10 and 110 control the change in the relative positional relationship between the recording head 30 and the medium ME0 by the drive unit 50 and the ejection of the liquid 36 from the recording head 30 such that the test pattern TP including the plurality of patches PA0 is formed on the medium ME0, the plurality of patches PA0 including a plurality of first characteristic patches including the first outer patch PA01 and the first inner patch PA11 and a plurality of second characteristic patches including the second outer patch PA02 and the second inner patch PA12. Further, it can be said that the control units 10 and 110 control the change in the relative positional relationship between the recording head 30 and the medium ME0 by the drive unit 50 and the ejection of the liquid 36 from the recording head 30 such that the test pattern TP is formed on the medium ME0 in which, in the main scanning direction D1, the patches PA are not adjacent to each other, the patches PA2 are not adjacent to each other and the patches PA3 are not adjacent to each other among the plurality of patches PA0.

After printing the test pattern TP, the control unit 110 of the information terminal 1 causes the display unit 116 to display a message prompting the user US1 to capture an image of the test pattern TP, and acquires the captured image IM0, which is the imaging result about the test pattern TP, from the imaging unit 120 (S108). That is, the control unit 110 acquires the imaging result about the plurality of patches PA0 included in the test pattern TP from the imaging unit 120. Alternatively, the control unit 110 may receive an input of the captured image IM0 from the internal storage unit 114 or an external storage medium via the operation unit 115. In processing of S108, the user US1 captures an image of the test pattern TP with the information terminal 1, and selects the captured image IM0 from the storage unit 114 or a storage area by operating the operation unit 115 as necessary.

After acquiring the imaging result, the control unit 110 determines the density difference DD for each characteristic patch based on the imaging result about the plurality of patches PA0 included in the test pattern TP (S110). The density difference determination processing of S110 can be performed, for example, as follows.

First, the control unit 110 specifies the test pattern formation area ARO based on the captured image IM0, and specifies positions of the respective patches PA0 present in the test pattern formation area ARO. The test pattern formation area ARO may be specified based on the position of the position detection pattern MKO included in the captured image IM0, or may be specified as a rectangular area surrounding a portion darker than the ground color of the medium ME0 in the captured image IM0 when the position detection pattern MKO is not present. When the test pattern formation area ARO is specified, the positions of the respective patches PA0 are specified by applying preset position information of the patches PA0 to the test pattern formation area ARO.

Next, the control unit 110 calculates an individual density difference DD of each patch PA0 based on an image of the patch PA0 included in the captured image IM0. As described above, the density difference DD is a value obtained by subtracting the density of the boundary portion BO from the density of the portion excluding the boundary portion BO in the patch PA0. For example, when the RGB average value of the boundary portion BO and the RGB average value of the portion excluding the boundary portion BO can be calculated based on the image of each patch PA0, the control unit 110 may calculate, as the individual density difference DD, a difference value obtained by subtracting the RGB average value of the portion excluding the boundary portion BO from the RGB average value of the boundary portion BO. When the lightness L of the boundary portion BO and the lightness L of the portion excluding the boundary portion BO can be calculated based on the image of each patch PA0, the control unit 110 may calculate, as the individual density difference DD, difference value obtained by subtracting the lightness L of the portion excluding the boundary portion BO from the lightness L of the boundary portion BO.

Further, the control unit 110 averages the individual density differences DD for each characteristic patch, and determines the obtained average value, for example, the additive average value, as the density difference DD for setting the adjustment value.

Specifically, for the first characteristic patch (PA1), the control unit 110 determines a value obtained by averaging the individual density differences DD of the respective patches PA as the density difference DD for setting the adjustment value. The individual density differences DD of two patches PA1 are examples of a plurality of values respectively representing the imaging results about the plurality of first characteristic patches. For the second characteristic patch (PA2), a value obtained by averaging the individual density differences DD of the respective patches PA2 is determined as the density difference DD for setting the adjustment value. The individual density differences DD of two patches PA2 are examples of a plurality of values respectively representing the imaging results about the plurality of second characteristic patches. For the third characteristic patch (PA3), a value obtained by averaging the individual density differences DD of the respective patches PA3 is determined as the density difference DD for setting the adjustment value. The individual density differences DD of two patches PA3 are examples of a plurality of values respectively representing the imaging results about the plurality of third characteristic patches.

Further, the density difference DD for each characteristic patch is not limited to the average value of the individual density differences DD, and may be a representative value of the individual density differences DD. Here, when a plurality of characteristic patches having the same characteristic are identified by a variable i and the brightness value acquired from the imaging result for each characteristic patch is represented by Y(i), the absolute value of the brightness value is |Y(i)|. The average value of the absolute values |Y(i)| is represented by Avg {|Y(i)|}. Each brightness value Y(i) may be a value obtained by subtracting the RGB average value of the portion excluding the boundary portion BO from the RGB average value of the boundary portion BO. The representative value is preferably an individual density difference DD representing the imaging result for a characteristic patch, among the plurality of characteristic patches having the same characteristic, satisfying that the absolute value | Y(i)| of the brightness value is equal to or greater than the average value Avg {|Y(i)|} of the absolute values of the plurality of brightness values. For example, the representative value may be an individual density difference DD representing the imaging result about the patch PA1 among the plurality of patches PAL in which the brightness value Y(i), which is the maximum value of the absolute values |Y(i)| of the plurality of brightness values, is acquired. For example, when the brightness values of two patches PA1 are 80 and 90, the maximum value of the absolute values |Y(i)| of the plurality of brightness values is 90, and when the brightness values of the two patches PA1 are −60 and −70, the maximum value of the absolute values |Y(i)| of the plurality of brightness values is 70.

In this case, it can be said that the control unit 110 determines, as the representative value, the individual density difference DD representing the imaging result for a characteristic patch, among the plurality of characteristic patches, satisfying that the absolute value |Y(i)| is equal to or greater than the average value Avg {| Y(i)|}.

After determining the density difference DD for each characteristic patch, the control unit 110 determines the adjustment value AD based on the density difference DD for each characteristic patch (S112). As illustrated in FIG. 5, based on the density difference DD (−2) obtained from the imaging results about the plurality of patches PA1, the density difference DD (0) obtained from the imaging results about the plurality of patches PA2, and the density difference DD (+2) obtained from the imaging results about the plurality of patches PA3, the approximate straight line L1 representing the correspondence relationship between the adjustment value AD and the density difference DD can be obtained. Therefore, the control unit 110 may determine, as the adjustment value to be set in the printing apparatus 2, the adjustment value AD at the point where the approximate straight line L1 and the AD axis intersect. As described above, the control unit 110 acquires the imaging results about the plurality of patches PA0 included in the test pattern TP from the imaging unit 120, and determines, based on the imaging results, the adjustment value AD for adjusting the printing characteristics. At this time, the control unit 110 may determine the adjustment value AD based on the density difference DD averaged for each characteristic patch, or may determine the adjustment value AD based on the individual density difference DD representing the imaging result for the characteristic patch satisfying that the absolute value |Y(i)| is equal to or greater than the average value Avg {|Y(i)|}.

Finally, the control unit 110 sets the determined adjustment value AD in the control unit 10 of the printing apparatus 2 (S114), and ends the printing characteristic adjustment processing. The control unit 10 of the printing apparatus 2 can adjust the feed amount in the sub-scanning direction D2 without excess or deficiency by adjusting the feed amount according to the adjustment value AD. For example, when the adjustment value AD is positive, a gap is generated between the band regions unless the feed amount is adjusted. Therefore, the control unit 10 performs the PF adjustment of reducing the feed amount according to the adjustment value AD. When the adjustment value AD is negative, a dark streak is generated between the band regions unless the feed amount is adjusted. Therefore, the control unit 10 performs the PF adjustment of increasing the feed amount according to the adjustment value AD.

In the plurality of patches PA0 arranged in the main scanning direction D1 in the test pattern TP printed as illustrated in FIG. 4, the patches PA1 are not adjacent to each other, the patches PA2 are not adjacent to each other, and the patches PA3 are not adjacent to each other. Accordingly, even when the shadow SHO is cast on one of the patches PA1, the possibility that the shadow SHO is not cast on another patch PAL increases, and even when the shadow SHO is cast on one of the patches PA2, the possibility that the shadow SHO is not cast on another patch PA2 increases, and even when the shadow SHO is cast on one of the patches PA3, the possibility that the shadow SHO is not cast on another patch PA3 increases. By acquiring the printing characteristics based on the imaging results about the plurality of patches PA0 including the plurality of patches PA1, the plurality of patches PA2, and the plurality of patches PA3, the influence of the shadow SHO on the acquisition of the printing characteristics is reduced. Therefore, in this specific example, it is possible to reduce the influence of the shadow SHO, which is generated at the time of imaging the test pattern TP, on the acquisition of the printing characteristics.

Further, the plurality of patches PA0 include outer patches (PA01, PA02) close to the end position P2 and inner patches (PA11, PA12) close to the intermediate position P1 in the test pattern formation area ARO. Accordingly, even if the imaging results about the outer patches (PA01, PA02) are affected by the aberration of the optical system such as the lens 121, the imaging results about the inner patches (PA11, PA12) reduce the influence of the aberration on the acquisition of the printing characteristics. Therefore, in this specific example, it is possible to reduce the influence of the aberration generated at the time of imaging the test pattern TP on the acquisition of the printing characteristics.

As illustrated in FIG. 7, examples of the printing characteristic adjustment include Bi-d adjustment and density adjustment in addition to the PF adjustment described above. FIG. 7 schematically illustrates examples of the printing characteristic adjustment.

The Bi-d adjustment means setting an adjustment value AD used to align the landing positions of the droplets 37 along the forward path and the landing positions of the droplets 37 along the backward path in the main scanning direction D1 when the printing apparatus 2 repeats the main scanning and the sub-scanning during printing. The forward path means the main scanning in which the recording head 30 moves in the forward direction D11, and the backward path means the sub-scanning in which the recording head 30 moves in the backward direction D12. For example, it is assumed that the landing positions in the backward path to be aligned with the landing positions in the forward path in the main scanning direction D1 are deviated in the forward direction D11 from the landing positions in the forward path, as illustrated in FIG. 7. In this case, the positions of the dots 38 formed on the medium ME0 in the backward path are deviated in the forward direction D11 from the positions of the dots 38 formed on the medium ME0 in the forward path. For example, the control unit 110 can cause the printing apparatus 2 to execute the Bi-d adjustment by setting the adjustment value AD, which corresponds to the positional deviation of the dots 38, in the control unit 10 of the printing apparatus 2. The control unit 10 of the printing apparatus 2 can delay an ejection timing of the droplets 37 from the recording head 30 in the backward path in accordance with the adjustment value AD to align the landing positions of the droplets 37 in the forward path with those in the backward path in the main scanning direction D1. Obviously, when the landing positions in the backward path to be aligned with the landing positions in the forward path in the main scanning direction D1 are deviated in the backward direction D12 from the landing positions in the forward path, the landing positions of the droplets 37 in the forward path can be aligned with those in the backward path in the main scanning direction D1 by setting the adjustment value AD.

The density adjustment means setting an adjustment value AD used to adjust the density of the printed image PIO to the density of an input image. For example, it is assumed that the printed image PIO is darker than the input image, as illustrated in FIG. 7. In this case, the output density of the patch PA0 is higher than the density of the patch print data DA1 for forming the patch PA0. For example, the control unit 110 can cause the printing apparatus 2 to execute the density adjustment by setting the adjustment value AD, which corresponds to the deviation of the output density of the patch PA0 with respect to the density of the patch print data DA1, in the control unit 10 of the printing apparatus 2. The control unit 10 can adjust the density of the printed image PIO to the density of the input image by reducing the output density of the patch PA0 corresponding to the patch print data DA1 to the density of the patch print data DA1 in accordance with the adjustment value AD. Obviously, even when the density of the printed image PIO is lower than that of the input image, the density of the printed image PIO can be adjusted to the density of the input image by setting the adjustment value AD.

The density adjustment of the printed image PIO may be performed in units of the nozzles 34.

### (4) MODIFICATIONS

Various modifications of the present disclosure are conceivable.

For example, the control unit 110 that performs the printing characteristic adjustment processing illustrated in FIG. 6 may be provided in a computer that is not provided with the imaging unit 120. In this case, the computer may be interpreted as being provided in the printing apparatus 2. The control unit 10 of the printing apparatus 2 may also serve as the control unit 110 to perform the printing characteristic adjustment processing illustrated in FIG. 6.

Further, the control unit 110 that performs the processing of S108 to S114 illustrated in FIG. 6 may be provided in a server (server computer) coupled to the information terminal 1 or the printing apparatus 2 via a network. In this case, the information terminal 1 and the printing apparatus 2 can transmit the imaging result about the test pattern TP to the server, and then receive the adjustment value AD from the server and set the adjustment value AD in the control unit 10 of the printing apparatus 2.

An entity that performs the above-described processing is not limited to the CPU, and may be an electronic component other than the CPU, such as an application specific integrated circuit (ASIC). Obviously, a plurality of CPUs may cooperate with one another to perform the above-described processing, or the CPU and another electronic component (for example, ASIC) may cooperate with each other to perform the above-described processing.

The number of characteristic patches having the same characteristic included in the test pattern TP is not limited to two, and may be three or more.

As illustrated in FIG. 8, the plurality of patches PA0 may be arranged in a matrix in the main scanning direction D1 and the sub-scanning direction D2 as an example of the intersecting direction in the test pattern TP on the medium ME0. Among the plurality of patches PA0 illustrated in FIG. 8, arrangement portions of y1 and y4 along the main scanning direction D1 include the patch PA1, the patch PA2, the patch PA3, the patch PA1, the patch PA2, and the patch PA3 in order in the main scanning direction D1. The arrangement order of the patches in arrangement portions of y2, y3, y5, and y6 along the main scanning direction D1 is different from that in the arrangement portions of y1 and y4. In addition, among the plurality of patches PA0 illustrated in FIG. 8, arrangement portions of x1 and x4 along the sub-scanning direction D2 include the patch PA1, the patch PA2, the patch PA3, the patch PA1, the patch PA2, and the patch PA3 in order in the feeding direction D3 opposite to the sub-scanning direction D2. The arrangement order of the patches in arrangement portions of x2, x3, x5, and x6 along the sub-scanning direction D2 is different from that in the arrangement portions of x1 and x4. Therefore, it can be said that, in the plurality of patches PA0, the patches PA1 are not adjacent to each other, the patches PA2 are not adjacent to each other, and the patches PA3 are not adjacent to each other in both the main scanning direction D1 and the sub-scanning direction D2.

In the printing characteristic adjustment processing illustrated in FIG. 6, the control units 10 and 110 can execute control of forming the patches PA0 of the arrangement portions of y1 to y6 on the medium ME0 by performing the processing of S102 to S106 six times. Specifically, it is sufficient for the control units 10 and 110 to print the patches PA0 of the arrangement portion of y1 in the processing of S102 to S106, then print the patches PA0 of the arrangement portion of y2 in the processing of S102 to S106, and similarly perform the processing of S102 to S106 for the arrangement portions of y3 to y6. In this manner, the control units 10 and 110 control the change in the relative positional relationship between the recording head 30 and the medium ME0 by the drive unit 50 and the ejection of the liquid 36 from the recording head 30 such that the test pattern TP is formed on the medium ME0 in which, in both the main scanning direction D1 and the sub-scanning direction D2 the patches PA1 are not adjacent to each other, the patches PA2 are not adjacent to each other, and the patches PA3 are not adjacent to each other among the plurality of patches PA0. When the imaging results about the plurality of patches PA0 included in the test pattern TP are acquired in S108, the control unit 110 can determine the adjustment value AD based on the imaging results in S110 to S112. Finally, the control unit 110 sets the adjustment value AD in the printing apparatus 2 in S114.

As described above, it is possible to reduce the influence of the shadow, which is generated at the time of imaging the test pattern TP including the plurality of patches PA0 arranged in the main scanning direction D1 and the sub-scanning direction D2, on the acquisition of the printing characteristics.

Although not illustrated, the plurality of patches PA0 included in the test pattern TP may be arranged in a single row in the sub-scanning direction D2. Also in this case, in the printing characteristic adjustment processing illustrated in FIG. 6, the control of forming the test pattern TP on the medium ME0 can be executed by performing the processing of S102 to S106 a plurality of times.

In this case, it is possible to reduce the influence of the shadow, which is generated at the time of imaging the test pattern TP including the plurality of patches PA0 arranged in the sub-scanning direction D2, on the acquisition of the printing characteristics.

In the specific example of the printing characteristic adjustment processing, although it has been described that the representative value of the individual density differences DD or the like may be used without being limited to the average value of the individual density differences DD, the method of obtaining the representative value is not limited to the method described above. What has been described in the specific examples is merely an example, and how imaging results about a plurality of test patterns TP are used to calculate a correction value may be determined in consideration of a well-known technique as appropriate.

For example, in a case of acquiring a printing characteristic of an adjustment item for which the influence of the shadow at the time of imaging is large and being brighter is preferable, a change may be made according to the print characteristic to be acquired such that a patch having a high brightness value is selected from a plurality of patches having the same characteristic.

### (5) CONCLUSIONS

As described above, according to the present disclosure, the various aspects can provide a configuration and the like capable of reducing the influence of the shadow, which is generated at the time of imaging the test pattern, on the acquisition of the printing characteristics. Obviously, the basic functions and effects described above can also be achieved by configurations having only configuration requirements according to the independent claims.

It is possible to implement a configuration in which the elements disclosed in the examples described above are replaced with one another or the combinations thereof are changed, a configuration in which the elements disclosed in known technologies and the examples described above are replaced with one another or the combinations thereof are changed, and the like. The present disclosure also includes such configurations and the like.

What is claimed is:

1. A test pattern forming method for forming, on a medium, a test pattern for acquiring a printing characteristic of a printing apparatus including a recording head configured to eject a liquid onto the medium,
the test pattern including a plurality of patches arranged in a predetermined direction,
the plurality of patches including a plurality of first characteristic patches indicating a first characteristic of the printing characteristic and further including a plurality of second characteristic patches indicating a second characteristic of the printing characteristic,
the test pattern forming method comprising:
a first step of changing a relative positional relationship between the recording head and the medium; and
a second step of ejecting the liquid from the recording head such that the test pattern is formed on the medium in which, in the predetermined direction, the first characteristic patches are not adjacent to each other and the second characteristic patches are not adjacent to each other among the plurality of patches.

2. The test pattern forming method according to claim 1, wherein
an area of the medium in which the test pattern is formed is set as a test pattern formation area,
in the test pattern formation area, the plurality of first characteristic patches include a first outer patch closer to an end position in the predetermined direction than to an intermediate position in the predetermined direction and a first inner patch closer to the intermediate position than to the end position, and
in the second step, the liquid is ejected from the recording head such that the test pattern including the plurality of patches including the plurality of first characteristic patches and the plurality of second characteristic patches is formed on the medium, the plurality of first characteristic patches including the first outer patch and the first inner patch.

3. The test pattern forming method according to claim 1, wherein
in the second step, the liquid is ejected from the recording head such that the test pattern including the plurality of patches is formed on the medium in which the first characteristic patch, the second characteristic patch, the first characteristic patch, and the second characteristic patch are arranged in order in the predetermined direction.

4. The test pattern forming method according to claim 1, wherein
the plurality of patches are arranged in the predetermined direction and an intersecting direction intersecting the predetermined direction in the test pattern, and
in the second step, the liquid is ejected from the recording head such that the test pattern is formed on the medium in which, in both the predetermined direction and the intersecting direction, the first characteristic patches are not adjacent to each other and the second characteristic patches are not adjacent to each other among the plurality of patches.

5. An adjustment value determination method including the test pattern forming method according to claim 1, the adjustment value determination method comprising:
a third step of determining an adjustment value for adjusting the printing characteristic based on an imaging result about the plurality of patches included in the test pattern, wherein
in the third step, a plurality of values respectively representing imaging results of the plurality of first characteristic patches are averaged, and the adjustment value is determined based on the averaged value.

6. An adjustment value determination method including the test pattern forming method according to claim 1, the adjustment value determination method comprising:
a third step of determining an adjustment value for adjusting the printing characteristic based on an imaging result about the plurality of patches included in the test pattern, wherein
the imaging result includes information with which acquisition of a plurality of brightness values each indicating brightness or a difference in brightness of the plurality of patches is enabled, and
in the third step, the plurality of brightness values are acquired from imaging results about the plurality of first characteristic patches, and the adjustment value is determined based on a value representing the imaging result for a first characteristic patch, among the plurality of first characteristic patches, satisfying that an absolute value of the brightness value is equal to or greater than an average value of absolute values of the plurality of brightness values.

7. An adjustment value determination method including the test pattern forming method according to claim 1, the adjustment value determination method comprising:
a fourth step in which a control unit acquires an imaging result about the plurality of patches included in the test pattern from an imaging unit and determines, based on the imaging result, an adjustment value for adjusting the printing characteristic.

8. A printing apparatus comprising:
a recording head configured to eject a liquid onto a medium;
a drive unit configured to change a relative positional relationship between the recording head and the medium; and
a control unit configured to control formation of a test pattern for acquiring a printing characteristic of the printing apparatus, wherein
the test pattern includes a plurality of patches arranged in a predetermined direction,
the plurality of patches include a plurality of first characteristic patches indicating a first characteristic of the printing characteristic, and further include a plurality of second characteristic patches indicating a second characteristic of the printing characteristic, and
the control unit controls the change in the relative positional relationship by the drive unit and the ejection of the liquid from the recording head such that the test pattern is formed on the medium in which, in the predetermined direction, the first characteristic patches are not adjacent to each other and the second characteristic patches are not adjacent to each other among the plurality of patches.
